(19) United States
(12) Patent Application Publication
(10) Pub. No.: US 2005/0198046 A1
(43) Pub. Date: Sep. 8, 2005

(54) System and method for dynamically linking data within a portable document file to a related data processing system

(75) Inventor: Michael J. McAuley, Glen Iris (AU)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 10/792,261

(22) Filed: Mar. 3, 2004

(51) Int. Cl. G06F 7/00

(52) U.S. Cl. 707/100

(57) ABSTRACT

A message server comprises web server systems for sending a first portable document file to a client system. The first portable document file comprises displayed data content selectable by the user and associated hidden data content. The hidden data content may be in a tagged data content format. The message server receives a message from the client system. The message comprises both: i) identification of the first portable document file; and ii) identification of the displayed data content selected by the user. The message sever uses the identification of the first portable document file and the identification of the displayed data content selected by the user to link the client system to a data processing system at a specified network address, the data processing system being related to the content selected by the user.

### TECHNICAL FIELD

The present invention relates generally to a system and method for presenting content in a portable document file and dynamically linking the content to a related data processing system.

### BACKGROUND OF THE INVENTION

The internet has become a popular means for enabling user's to access data content available on a web server. Typically, a user accesses data content on a web server utilizing a client computer that is operating applicable TCP/IP protocols for communicating over the internet and a thin client web browser for accessing and displaying the data content on a display screen (or printing the data content on a printer) associated with the client computer.

The most popular document format, and the format that most web browsers are configured to display, is a Hypertext Markup Language (HTML) document. The web browser retrieves an HTML document associated with a Universal Resource Locator (URL) address by opening a TCP/IP connection with the web server at the URL and sending an HTTP (Hypertext Transport Protocol) “get” command to the web server over the TCP/IP connection. In response to receiving the “get” command, the web server provides the HTML document to the client computer in an HTTP package for display by the browser.

The HTML document comprises certain codes or metadata (defined within the applicable HTML standards) embedded within the document's text based data content. The codes define how the content should be displayed by the browser. For example, codes define such display attributes as document background color, text font, and text font size. Certain codes may also be used to identify the URL addresses of other files (for example digital graphics) to be inserted within the HTML document for display.

The HTML document may also contain interactive commands. One well known interactive command is a Hypertext Link. A Hypertext Link identifies another document by the URL address at which it is located, If the Hypertext link is activated by the user, the browser will open an new TCP/IP session with the web server associated with the URL for retrieving the document.

Another well known interactive command is an HTTP post command. An HTTP post command operates to post text, identified by code in the HTML document, from the browser window to particular URL identified in the HTML document. The posted text may be text coded into the document or text input by the user into a text window in the document. In which case, the coding in the document identifies the user input text.

The web server that receives the posted data then performs processing steps at the server to select or build an HTML document for providing to the user's computer as a response to the post command.

There are several problems related providing data content to a user utilizing an HTML document. First, the HTML document itself can not display a digital image and displayable graphics are very limited. As such, digital images (and complex graphics formatted as a digital image) are displayed within an HTML document by including the URL to a separate digital graphic file and applicable codes for the display of such graphic file within the HTML document. As such, HTML is not practical for the display of standard business forms wherein graphic layout is utilized to make the data content more understandable because: i) the graphic would need to be a separate file linked to the HTML document by URL; and ii) the graphic is a static display only—HTML does not include any provisions for user interaction with the graphic.

Secondly, the display of the document is determined by the browser's interpretation of the HTML codes and the width of the display window (either a display screen or a printed page). Therefore, display may be inconsistent from browser to browser. As such HTML is not even a practical means for presenting non-graphic textual data content if precise formatting (such as high density rows and columns) must be maintained to make the data content understandable because there are no assurances that the browser will maintain such formatting for both display and printing.

The Portable Document File (PDF) format has been developed by Adobe Systems of San Jose California as a better means for presenting data content wherein graphic layout can be used to make the data content more comprehensible. In response to an HTTP “get” command, a web server may provide a PDF document within a HTTP package. The browser passes the PDF document to a PDF reader (such as Adobe Acrobat®) for viewing.

The PDF format includes logical objects with both data content and meta data. The data content may be text, graphics, or image. The meta data comprises instructions for precise formatting and positioning of the data content within the display. The meta data may also include interaction instructions providing for such interaction as: i) enabling a user to type data within portions of the document to “complete a form”; and ii) enabling certain data content to be associated with a hypertext link for opening a TCP/IP connection and sending an HTTP “get” command to a URL defined within the hypertext link; and iii) posting text data identified in the PDF document to a URL identified in the PDF document utilizing an HTTP “post” command.

While PDF is an improvement over HTML for display of data content wherein graphic formatting is used to facilitate user comprehension, some drawbacks still remain with existing systems. Primarily, the hypertext link within a PDF document for either an HTTP “get” command or an HTTP “post” command is static. More specifically, activation of a hypertext link within the PDF document will always initiate the “get” or “post” to the URL encoded within the PDF document.

As such: i) activation of the hypertext link will only obtain the desired result so long as the service provider maintains the content on the web server at the particular URL encoded in the PDF document; ii) activation of a “get” command hypertext link will always obtain the document associated with the coded URL independent of any work process flow in which the HTML document was presented to the user and independent of the identity of the user to which the document was sent; and iii) activation of a “post” command hypertext link will always post the same data (or user entered data field) to the same URL coded in the document independent of any work process flow in which the HTML document was presented to the user and independent of the identity of the user to which the document was sent.

What is needed is a system that provides the benefits of presenting data content utilizing the portable document format and further includes a system and method to enable dynamic linking between data content within the portable document to other data content that does not suffer the disadvantages of known data linking systems.

### SUMMARY OF THE INVENTION

A first aspect of the present invention is to provide a message server. The message server comprises web server systems for sending a first portable document file to a client system. The first portable document file comprises displayed data content selectable by the user and associated hidden data content. The hidden data content may be in a tagged data content format. The message server also sends a message server address to the client system. The message server address is sent as part of a message server address update message which is a file distinct from the first portable document file. The message server address may be a URL at which the message server receives messages from the client system.

The message server receives a message from the client system at the message server address. The message comprises both: i) identification of the first portable document file; and ii) identification of the displayed data content selected by the user. The message sever uses the identification of the first portable document file and the identification of the displayed data content selected by the user to at least one of: i) locate and provide a second portable document file that is related to the content selected by the user, and ii) link the client system to a data processing system at a specified network address—the data processing system being related to the content selected by the user.

The work flow module may comprise work flow tables. The work flow module utilizes the work flow tables to map the identification of the first portable document file and the identification of the displayed data content selected by the user to one of a plurality of objects, each for building a different type of instruction message.

The message may further comprises identification of the user of the client system. In which case, the work flow module uses the identification of the user of the client system to determine whether the user has permissions to access the data processing services at the specified network address and provides the instruction message to the client system only if the user of the client system has permissions to access such data processing services.

More specifically, the work flow module may utilize the work flow tables to: i) map the identification of the user of the client system to an access level; ii) compare the access level to a required access level; and iii) provide the instruction message to the client system only if the access level is greater than or equal to the required access level.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing a system for dynamically linking between data content within a first portable document to related data and data processing systems in accordance with an exemplary embodiment of the present invention;

FIG. 2 represents an exemplary document file in accordance with one embodiment of the present invention;

FIG. 3 represents an exemplary message provided in response to user interaction with a document in accordance with one embodiment of the present invention;

FIG. 4 is a flow chart representing exemplary operation of a plug-in module in accordance with one embodiment of the present invention;

FIGS. 5a through 5d represent instructions provided by a message server in accordance with one embodiment of the present invention;

FIG. 6 is a table representing commands executable by a plug-in module in accordance with one embodiment of the present invention FIG. 7 is a table representing an exemplary executable mapping system in accordance with one embodiment of the present invention;

FIGS. 8a through 8e represent exemplary executable objects operated by the message server in accordance with one embodiment of the present invention; and

FIG. 9 represents an exemplary application of the teachings of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

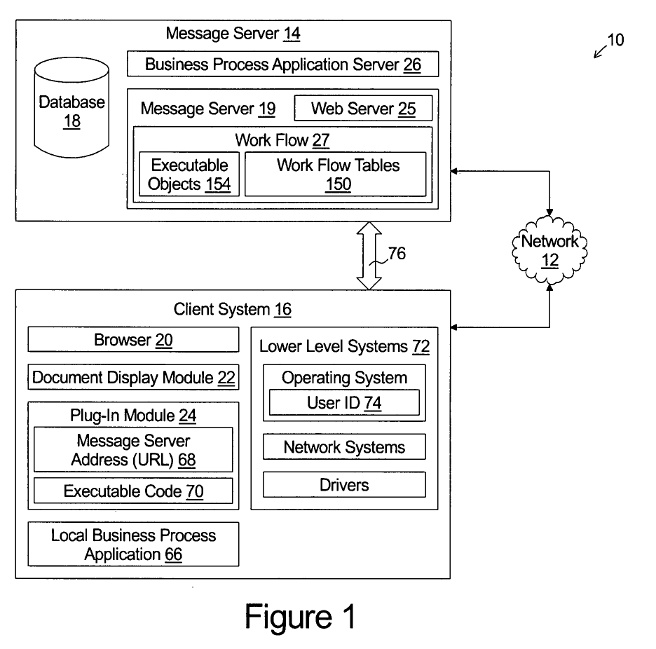

FIG. 1 illustrates exemplary architecture of a system 10 for dynamically linking data content within a first portable document 28 to related data content and data processing systems. The related data content and data processing systems comprise: i) other documents stored within a database 18; ii) business processes provided by a business process application server 26; and iii) business processes provided by a local business process software application 66—each of which is discussed in more detail herein. The system 10 comprises at least one client system 16 coupled to a message system 14 via the Internet 12.

The client system 16 comprises typical computer hardware and lower level software components such as an operating system, network systems, and drivers (collectively, the lower level systems 72) which provide services to application level software making processing calls thereto. At the application level, the client system 16 comprises a browser 20, a document display module 22, a message plug-in module 24, and the local business process software application 66.

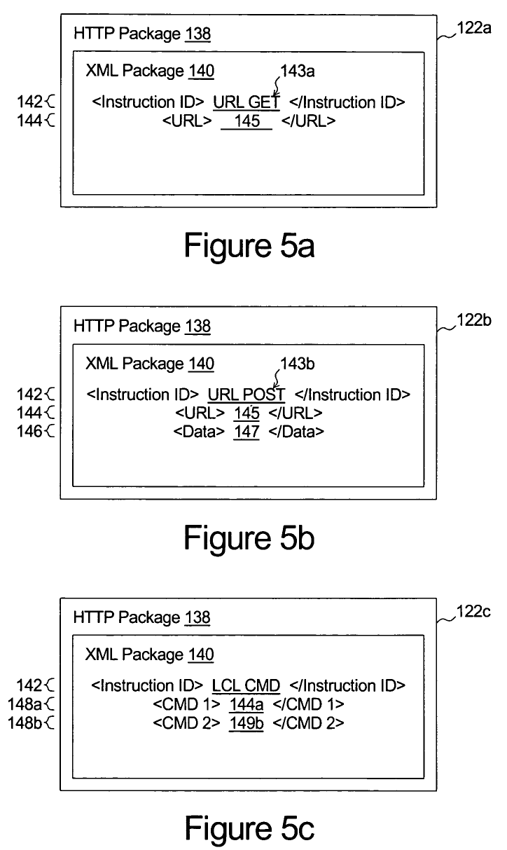

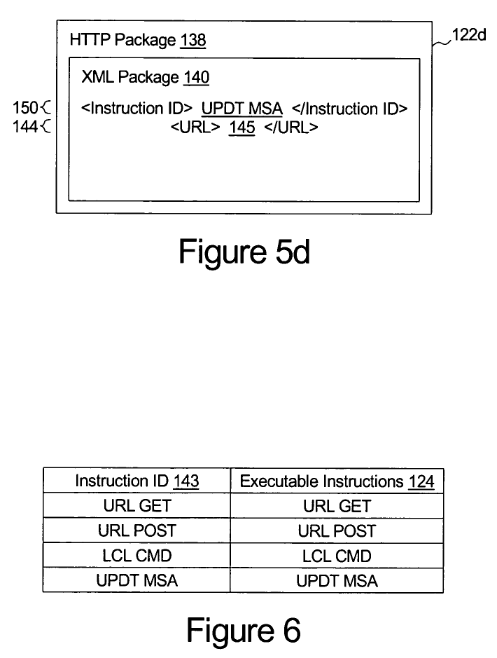

The browser application 20 may be a known thin client browser application such as Microsoft® Explorer®, Netscape® Navigator®, or similar functioning software for establishing a TCP/IP session with a web server in response to user input of a universal resource locator (URL) address (or user selection of a hypertext link within a document) and receiving an HTTP package in response thereto. If the HTTP package comprises an HTML document, the document is displayed by the browser application 20. If the HTTP package comprises a document of a format displayable by the document display module 22 (such as a document in the Adobe® Portable Document File (PDF) format), the document is passed to the document display module 22 for display. If the HTTP package contains a message 122 (FIGS. 5a-5d) for the message plug-in module 24, the message 122 is passed to the message plug-in module 24.

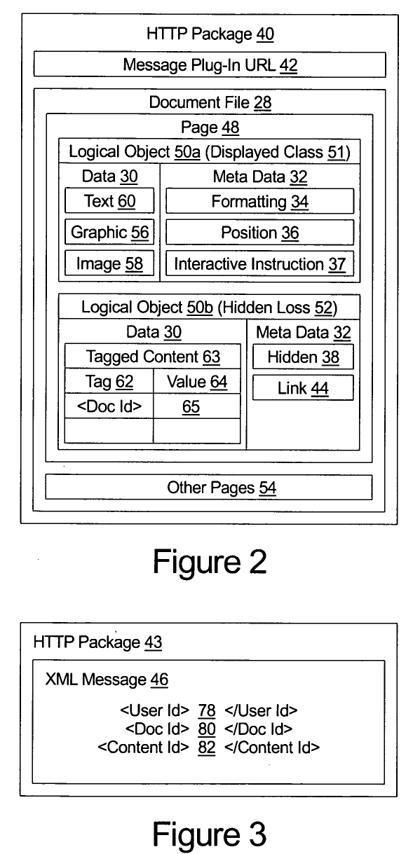

The document display module 22 may be a known module for displaying documents in the Adobe PDF format. An exemplary document display module 22 is the Acrobat® Reader available from Adobe Systems. Upon receipt of a document in the PDF format, the document display module 22 will display each page as originally provided when the document was authored independent of display size and resolution. More specifically, and with brief reference to FIG. 2 in conjunction with FIG. 1, an exemplary document 28 will include at least one page 48. Within the page 48 are a plurality of logical objects 50—at least a portion of which will be of a display class 51 of logical objects recognized by the document display module 22. The document display module 22 will display the text 60, graphic 56, or image 58 data content 30 of the display class 51 logical object on a display screen associated with the client system 16 in accordance formatting 34, positioning 36, and interaction 37 instructions set forth in meta data 32 associated with the data content 30.

The message plug-in module 24 couples to plug-in application programming interfaces (APIs) of the document display module 22 to access the logical objects 50 of the document 28. The plug-in module 24 detects user selection (e.g. mouse click) of data content 30 displayed on the display screen, generates a message 46 (FIG. 3) in response to the user selection of the message system 14, establishes a TCP/IP session 76 to a message server 19 of the message system 14, and sends the message 46 to the to the message server 19 indicating the user selection. The plug-in module 24 may further receive documents 28 (FIG. 2) or instructions 122 (FIGS. 5a-5d) from the message server 19. If a document 28 is received, the plug-in module 24 may pass the document 28 to the document display module 22 for display on the display screen. If an instruction 122 is received, execute the instruction. A more detailed description of the message plug-in module 24 is included herein.

The message system 14 comprises a business process application server 26, a database 18, and the message server 19.

The business process application server 26 may be a known “fat server/thin client” architected system for recording the transactions and processes of a business. An exemplary business process application server 26 would be one of the known enterprise resource management (ERP) systems. For purposes of the present invention, the business process application server 26 may be any system that enables a thin client browser based system to navigate menus provided by the server 26, post transactions to the server 26, and obtain data from the server 26 utilizing standard HTTP interaction with the server 26.

The database 18 may comprise a plurality of documents 28 which may be selected by the message server 19 and passed to the plug-in module 24 for display on the display screen.

The message server 19 comprises a web server module 25 and a work flow module 27. The web server module 27 includes known systems to enable an application running on the client system 16 (and specifically the plug-in module 24 running on the client system 16) to establish a TCP/IP session 76 with the message server 19.

The work flow module 27 enables the message server 19 to provide related documents and/or instructions to the plug-in module 24 in response to receipt of a message 46 (FIG. 3) from the plug in module 24. A more detailed discussion of the message server 19 is included herein.

In operation, the client system 16, or more specifically the browser application 20 of the client system 16, utilizes known techniques to establish a TCP/IP session with the web server 25 of the message server 19 and obtains a first document 28 from the message server 19 encapsulated in an HTTP package 40.

The HTTP package 40 may include a message plug-in URL 42 in conjunction with the document 28 such that the client system 16 may download the message plug-in module 24 if not already loaded on the client system 16.

The document 28 is passed to the document display module 22 for display on the display screen. Once displayed, user selection (e.g. mouse click) of displayed content 30 will trigger the message plug-in module 24 to open the TCP/IP session 76 and pass a message 46 (FIG. 3) to the message server 19.

Referring briefly to FIG. 3 in conjunction with FIG. 1, the message 46 contains ID data 78 which identifies the user of the client system 16, document ID data 80 which identifies the document 28, and content ID 82 which identifies the data content 30 of the document 28 selected by the user.

In response to receiving the message 46, the message server 19 may provide the related data content or instructions to link the plug-in module 24 to related data processing systems based on the ID data 78, the document ID data 80, and the content ID 82

The related data content may comprise: i) another document 28 selected from documents available in the database 18; and ii) a document built by the message server 19. Such a document may include fields requiring data entry by the operator such that the message server 19 may obtain additional information from the user.

The data processing systems may comprise: i) an instruction which instructs the message plug-in module 24 to establish a session with the business process application server 26 at a specified URL, and ii) an instruction which instructs the message plug-in module 24 to launch the local business process software 66 on the client system 16. A more detailed discussion of the message server 19 is included herein.

Document

Referring to FIG. 2, the document 28 may be a PDF document that includes at least one page 48 and optionally multiple other pages 54, for device independent and resolution independent display.

As discussed, the page 48 comprises a plurality of logical objects 50, each of which comprises data content 30 and meta data content 32. The first logical object 50a is a display class 51 logical object which is recognized by, and displayed by, the document display module 22. The data content 30 of the first logical object 50a may comprise any of a graphic 56, an image 58, or text data 60. The graphic 56 may be in any format which complies with the PDF standards. The image 58 may be an image formatted utilizing a known compression technology such as JPEG, GIFF, or TIFF.

The meta data 32 of display class 51 logical objects comprises instructions for the display of the data content 30. More specifically, if the data content 30 is text data 60, the meta data 32 may specify the formatting 34 and the position of the formatted text within the page. If the data is graphics 56 or an image 58, the meta data 32 may include display attributes and position within the page.

Further yet, the meta data 32 may comprise an interactive instruction 37. The interactive instruction 37 may comprise executable instructions for performing specified steps in response to user interaction with the data content 30. For example, if the interactive instruction 37 is a hypertext link, the interactive instruction 37 provides for calling the hypertext link functionality of the browser 20 to initiate a TCP/IP session and an HTTP “get” command to a URL coded into in the interactive instruction 37.

The second logical object 50b is of a hidden object class 52 which is recognized by the message plug-in module 24 but is hidden from display. The document display module 22 may either: i) not recognize the hidden object class 52 and therefore ignore it, or ii) recognize the hidden object class 52 and provide for it not to be displayed.

The data content 30 of hidden class 52 logical objects may be tagged data content 63. Tagged data content comprises a plurality of data values 64, each identified by a data tag 62. Exemplary tagged data content may be implemented using known Extensible Mark-UP Language (XML) techniques.

The meta data 32 of the hidden class 52 logical object may comprise: i) a hidden command 38 specifying that the data 30 is hidden or otherwise not displayed as part of the document 28; or iii) other commands unrecognized by or interpretable by the display module 22 such that the data content 30 remains hidden from view on the display screen. The meta data 32 may also include an active link command 44 associating the tagged content 63 to an active portion of data content 30 from the display class 51 logical object.

Message Plug-In Module

As discussed, the message plug-in module 24 utilizes the plug-in APIs of the document display module 22 to access the logical objects 50 of the document 28. The plug-in module 24 specifically recognizes the hidden class 52 logical objects, detects user selection (e.g. mouse click) of data content 30 of display class 51 logical objects, and sends a message 46 (within an HTTP package 43) over the TCP/IP session 76 to the message server 19 in response to detecting user selection of displayed content.

As discussed, the message 46 comprises contains ID data 78 which identifies the user of the client system 16, document ID data 80 which identifies the document 28, and content ID 82 which identifies the content of the document 28 selected by the user. In the exemplary embodiment, the message 46 comprises a package 45 identifying the message 46 as containing tagged data elements and includes each of the user ID data 78, the document ID data 80, and the content ID 82 as data elements associated with applicable data tags. Again, such tagged data content may be implemented using known Extensible Mark-UP Language (XML) techniques.

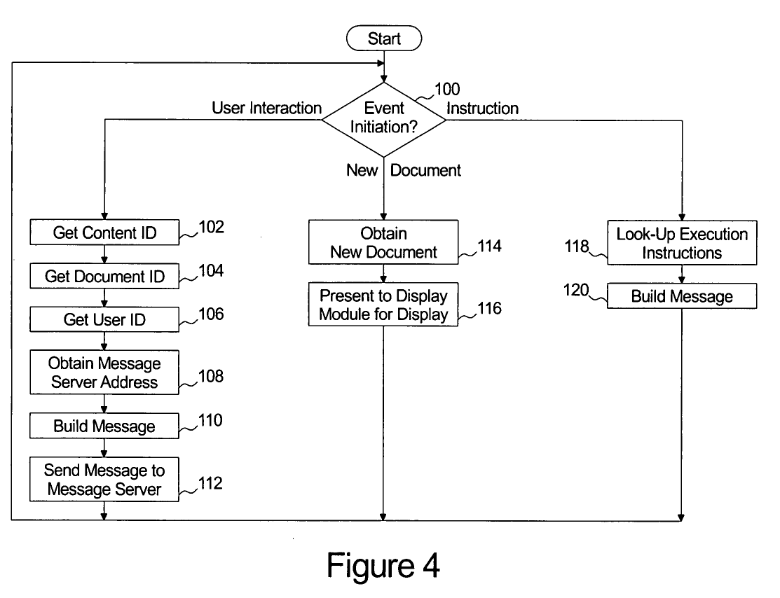

The flow chart of FIG. 4 represents exemplary operation of the message plug-in module 24. The message plug-in module 24 is an event driven application which performs certain predefined steps in response to certain predefined events. The events can be classified into three types of events, user interaction with the document 28, receipt of a new document 28 for display, and receipt of instructions from the message server 19. Box 100 represents an event loop in which the message plug-in module 24 awaits an event.

In the event that the plug-in module 24 detects user mouse activity which represents the user selecting data content 56, 58, or 60 within the document 28 as displayed by the document display module 22 on a screen associated with the client system 16, the plug-in module 24 executes steps 102 through 112 before again returning to the event loop at box 100.

Step 102 represents obtaining content ID data 82 associated with the data content 56, 58, or 60 selected by the user. As discussed, the meta data link 44 of the hidden class 52 logical object associates the tagged data content 63 with content 56, 58, and 60 of the display class 51 logical object. As such, step 102 represents using the meta data link 44 to locate the tagged content 63 data value 64 which corresponds to the selected content 56, 58, or 60.

Step 104 represents obtaining document ID data 80 associated with the document 28 which includes the content 56, 58, or 60 selected by the user. The document ID data 80 may include the name of the document 28, or other identifying indicia included within the document. For example, a document ID number 65 may be included as data 30 within a logical object of the hidden class 52.

Step 106 represents obtaining user ID data 78. In the exemplary embodiment, the lower level systems 72, and particular the operating system of the lower level systems 72, requires the user to log on to the client system 16 using a login ID and password. Step 106 represents retrieving the user's login ID from the operating system.

Step 108 obtaining a message server address 68 corresponding to the message server 19. In the exemplary embodiment, the message server address 68 is a URL of the message server 19 stored locally at the client system 16. As will be discussed later, the message server 19 may instruct the message plug-in module 24 to change or update the locally stored message server address 68.

Step 110 represents building the message 46 within an XML package 45. The XML package 45 may identify the XML parameters (such as version number) with which the message complies such that the tagged content data is interpretable by the message server 19. Within the XML package, the user ID 78, document ID 80, and content ID 82 are included with identifying data tags.

Step 112 then represents packaging the message 46 in an HTTP package 43 and sending the HTTP package to the message server 19 over the TCP/IP session 76. As such, step 112 may include opening the TCP/IP session 76 in the event that it has not previously been opened or it has timed out.

In the event that a new document 28 is provided to the plug-in module 24, the plug-in module executes steps 114 and 116 before again returning to the event loop at step 100.

Step 114 represents receiving the new document 28. The new document 28 may be wrapped in an HTTP package 40 and provided by the message server 19 to the plug-in module 24 over the TCP/IP session 76. In response to receiving the new document 28, the plug-in module 24 provides the new document 28 to the document display module 22 for display on the screen associated with the client system 16 at step 116. This new document 28 now takes the place of the previous document and user interaction with the new document 28 may be an event that causes the plug-in module 24 to perform steps 102 through 112, as previously discussed, to provide a message 46 to the message server 19.

In the event that an instruction is provided to the plug-in module 24, the plug-in module executes steps 118 and 120 before again returning to the event loop at step 100. For purposes of illustrating the present invention, it is envisioned that the message server 19 may provide any of four instruction classes to the plug-in module 24 including: i) an instruction to obtain a document form a specified URL; ii) an instruction to post data to a specified URL; iii) an instruction to execute local commands (e.g. commands on the client system 16); and iv) an instruction to update the URL of the message server 19.

Referring briefly to FIG. 5a, an exemplary instruction 122a to obtain a document at a specified URL is shown. The instruction 122a may comprise an XML message 140 within an HTTP package such that the instruction 122a may be sent from the message server 19 to the plug-in module over the TCP/IP session 76.

The XML message 140 may comprise a plurality of data tags 142 and 144 identifying data values 143a and 145. The data tag 142 <Instruction ID> identifies data value 143a which is a unique code predetermined to represent the instruction to obtain a document at a specified URL—in this case, the unique code is “URL GET”. The data tag 144 <URL> identifies a data value 145 which is the URL at which the document is located.

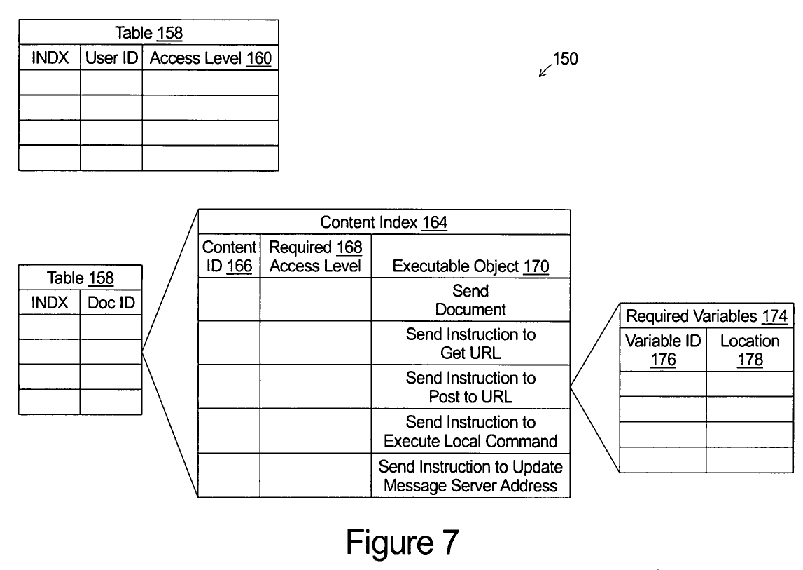

Returning to FIG. 4, step 118 represents looking up executable steps to perform the instruction identified by the <Instruction ID> data tag 142. Turning briefly to FIG. 6, the plug-in module 24 maintains executable instructions 124 in association with each possible instruction ID value 143 that could be included in an instruction 122 from the message server 19.

Returning to FIG. 4, step 120 represents executing the executable instructions 124—which, in the example of an URL GET instruction 143a, comprises establishing an TCP/IP connection to the specified URL 145 and utilizing an HTTP “get” message to obtain the document.

The URL GET instruction is useful for instructing the plug-in module to obtain a document available on any web server or to initiate a session with the business process application server 26 by obtaining HTML (or other web document) representing a start up screen or an initial menu of functions available to the user.

Referring briefly to FIG. 5b, an exemplary instruction 122b to post data to a specified URL is shown. The instruction 122b, like instruction 122a, comprises an XML message 140 within an HTTP package such that the instruction 122b may be sent from the message server 19 to the plug-in module over the TCP/IP session 76.

The XML message 140 of the instruction 122b may comprise a plurality of data tags. The data tag 142 <Instruction ID> identifies data value 143b which is a unique code predetermined to represent the instruction to post data to a specified URL—in this case, the unique code is “URL POST”. The data tag 144 <URL> identifies a data value 145 which is the URL to which the data is to be posted. The data tag <DATA> 146 identifies a data value 147 to post to the URL.

Returning to FIG. 4, in response to receiving a URL POST instruction 122b, the plug-in module 124 obtains executable instructions 124 corresponding to the Instruction ID 143 at step 118 and executes such instructions at step 120—which in this example includes establishing a TCP/IP connection to the specified URL 145 and utilizing an HTTP “post” message to post the data 147 to the server associated with the URL 145.

The URL POST instruction 112b is useful for instructing the plug-in module 24 to establish a session with any web server or the business process application server 26 by sending data thereto.

Referring briefly to FIG. c, an exemplary instruction 122c to execute a local command is shown. The instruction 122c, like instruction 122a, comprises an XML message 140 within an HTTP package 138 such that the instruction 122c may be sent from the message server 19 to the plug-in module over the TCP/IP session 76.

The XML message 140 of the instruction 122c may comprise a plurality of data tags. The data tag 142 <Instruction ID> identifies data value 143c which is a unique code predetermined to represent the instruction to execute a local command—in this case, the unique code is “LCL CMD”. The data tags 148a and 148b (e.g. <CMD1> and <CMD2>) identify commands 149a and 149b respectively which are to be sequentially executed on the client system 16.

Referring again to FIG. 4, in response to receiving a LCL CMD instruction 122c, the plug-in module 124 obtains executable instructions 124 corresponding to the Instruction ID 143c at step 118 and executes such instructions at step 120—which in this example includes executing each local command.

In the exemplary embodiment, the local commands may be commands for launching the local business process application software 66 and inputting data thereto.

Referring briefly to FIG. 5d, an exemplary instruction 122d to update the message server address is shown. The instruction 122d, like instruction 122a, comprises an XML message 140 within an HTTP package 138 such that the instruction 122c may be sent from the message server 19 to the plug-in module over the TCP/IP session 76.

The XML message 140 of the instruction 122d may comprise a plurality of data tags. The data tag 142 <Instruction ID> identifies data value 143d which is a unique code predetermined to represent the instruction to update the message server address 25—in this case, the unique code is “UPDT MSA”. The <URL> data tag 144 identifies the new URL to be used as the updated message server address.

Referring again to FIG. 4, in response to receiving a UPDT MSA instruction 122d, the plug-in module 124 obtains executable instructions 124 corresponding to the Instruction ID 143d at step 118 and executes such instructions at step 120—which in this example includes writing the new URL to the message server address record 68 stored locally at the client system 16.

Message Server

As discussed, the message server 19 comprises a web server module 25 and a work flow module 27 with the web server module 25 including known systems to enable the plug-in module 24 to establish the TCP/IP session with the message server 19.

The work flow module 27 comprises work flow tables 150, an executable index 152, and executable objects 154. In operation, the work flow module 27 receives each XML message 46 sent to the message server 19 from the message plug-in module 24 and executes an action based on the content of the message 46. More specifically, based on the content of the message, the work flow module 27 may provide another document 28 to the plug-in module 24 or send an instruction to the plug-in module 24 instructing the plug in module to: i) obtain a document from a specified URL; ii) post data to a specified URL; iii) execute local commands on the client system 16; and iv) update the message server address 68.

Referring to FIG. 7, the work flow tables may comprise a database which maps each combination of a user ID, a document ID, and a content ID to an action code. The action code specifies the response of the message server 19 to the plug in module 24. Exemplary work flow tables comprise a user table 158 which associates with each user ID with an access level value 160. It should be appreciated that in the event that a message 46 comprises a user ID which is not listed in the user table 158, a default access level value 160 may apply.

The work flow tables 150 may further comprise a document index 162. The document index 162 may comprise a first table which indexes the document ID of each available document. Associated with (or keyed off of) such document ID is a contents index 164 which associates data content 30 of the document (by content ID 166) with a required access level 168 and an executable object 170.

Further, a required variables index 174 associates, with the executable object 170, a list of variables (by variable ID 176) required to call the executable object 170. Associated with each variable ID 176 is a source 178—which may either be a variable value, a location where the variable may be obtained, or an executable object that may be called to calculate or determine the variable value based on the user ID, the document ID, and the content ID. More specifically, the variable ID 176 may specify a data tag which must be used to identify a variable value when calling the executable object 172. If the source 178 is a location where the variable may be obtained, the source 178 may specify a data tag associated with the location within storage at the message server 19 or storage at the local system 16.

The work flow module 27 will call the executable object 172 only if the access level 160 associated with the user ID is greater than or equal to the required access level 168 associated with the data content 30 in the document 28 selected by the user. The term greater than or equal to in this context is used to mean that the user has been granted access permissions which at a minimum permit the user to access the related data content or related data processing systems associated with the selected data content.

The exemplary executable objects 170 comprise: i) an object for sending another document 28 to the plug-in module 24, ii) an object for sending an instruction to the plug-in module 24 which instructs the plug-in module 24 to obtain a document from a specified URL; iii) an object for sending an instruction to the plug-in module 24 which instructs the plug-in module 24 to post data to a specified URL; iv) an object for sending an instruction to the plug-in module 24 which instructs the plug-in module 24 to execute local commands on the client system 16; and v) an object for sending an instruction to the plug-in module 24 which instructs the plug-in module 24 to update the message server address 68.

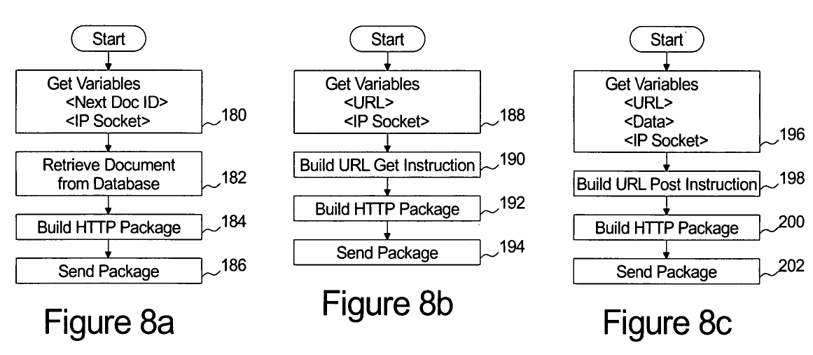

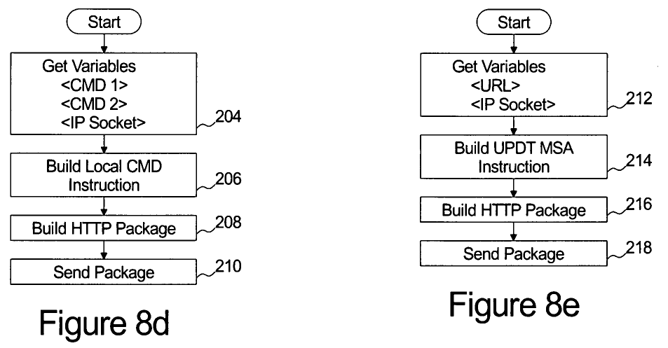

The flow chart of FIG. 8a represents exemplary steps of an executable object for sending another document 28 to the plug-in module 24. Step 180 represents obtaining variable values required for retrieving the next document 28 from the database 18 and sending such next document 28 to the plug-in module 24. The variables include the identity and/or location of the next document within the database 18 and the IP socket of the TCP/IP connection 76. Step 182 represents retrieving the next document 28 from the database 18, step 184 represents building the HTTP package 40 (FIG. 2) and step 186 represents sending the package 40 to the plug-in module 24.

The flow chart of FIG. 8b represents exemplary steps of an executable object for sending an instruction to the plug-in module 24 which instructs the plug-in module 24 to obtain a document from a specified URL. Step 188 represents obtaining variable values required to build a URL GET instruction 122a (FIG. 5a) and sending such instruction to the plug-in module 24. The variables include the specified URL and the IP socket of the TCP/IP connection 76. Step 190 represents building the URL Get instruction 122a, step 192 represents building the HTTP package 138 and step 194 represents sending the package 138 to the plug-in module 24.

The flow chart of FIG. 8c represents exemplary steps of an executable object for sending an instruction to the plug-in module 24 which instructs the plug-in module 24 to post data to a specified URL. Step 196 represents obtaining variable values required to build a URL POST instruction 122b (FIG. 5b) and sending such instruction to the plug-in module 24. The variables include the specified URL, data to post to the specified URL, and the IP socket of the TCP/IP connection 76. Step 198 represents building the URL POST instruction 122b, step 200 represents building the HTTP package 138 and step 194 represents sending the package 138 to the plug-in module 24.

The flow chart of FIG. 8d represents exemplary steps of an executable object for sending an instruction to the plug-in module 24 which instructs the plug-in module 24 to execute local commands on the client system 16. Step 204 represents obtaining variable values required to build a LCL CMD instruction 122c (FIG. 5c) and sending such instruction to the plug-in module 24. The variables include the commands (CMD1, CMD2) to execute locally and the IP socket of the TCP/IP connection 76. Step 206 represents building the LCL CMD instruction 122c, step 208 represents building the HTTP package 138 and step 210 represents sending the package 138 to the plug-in module 24.

The flow chart of FIG. 8d represents exemplary steps of an executable object for sending an instruction to the plug-in module 24 which instructs the plug-in module 24 to update the message server address 68. Step 212 represents obtaining variable values required to build a UPDT MSA instruction 122d (FIG. 5d) and sending such instruction to the plug-in module 24. The variables include the updated URL and the IP socket of the TCP/IP connection 76. Step 214 represents building the UPDT MSA instruction 122d, step 216 represents building the HTTP package 138 and step 218 represents sending the package 138 to the plug-in module 24.

### Exemplary Application

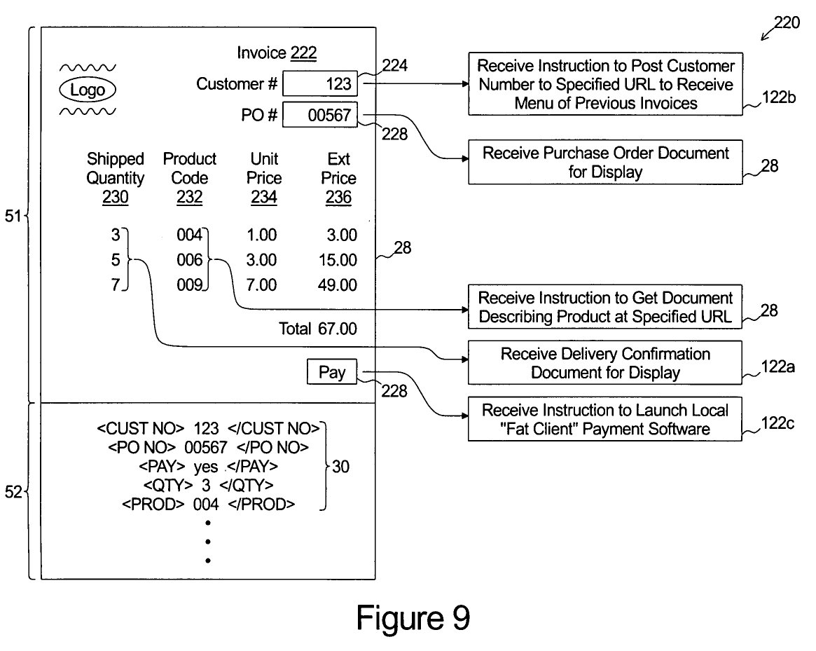

FIG. 9 represents an exemplary application of the present invention. In the exemplary application 220, the PDF document presented for viewing on the screen associated with the client system 16 is an invoice 222. The invoice 222 comprises data content 30 within display class 51 (FIG. 2) logical objects which includes a customer number field 224 which includes a customer number value of “123”, a purchase order number field 226 which includes a purchase order value of “00567”, a graphic button 228 indicating a function of paying the invoice, and a plurality of rows of data related to product being invoiced. Each row of data comprises a quantity shipped field 230, a product code field 232, a unit price field 234, and an extended price field 236.

Each of the displayed fields 224, 226, 228, 230, 232, 234, and 236 is associated with content data 30 within hidden class 52 (FIG. 2) data objects. Upon user interaction with the displayed data content, the plug-in module 24 will send an applicable message 46 to the message server 19 and receive a response from the message server 19.

In the event that the user selects the customer number “123”, the message 46 will include (with the user ID and document ID) tagged data content comprises a data tag of <CUST NO> and the data value of “123”. In response to receiving the message 46, the message server may respond with an URL POST instruction 122b (FIG. 5b) to post the customer number “123” to a specified web page controlled by a “fat server/thin client” accounting system such that the accounting system may provide a menu of previous invoices that are viewable.

In the event that the user selects the PO number “00567”, the message 46 will include (with the user ID and document ID) tagged data content comprises a data tag of <PO NO> and the data value of “00567”. In response to receiving the message 46, the message server 19 may retrieve the purchase order numbered “00567” from the database 18 and provide it to the plug-in module 24 as a new document 28.

In the event that the user selects the “pay” button 228, the message 46 will include (with the user ID and document ID) tagged data content which comprises a data tag of <PAY> and the data value of “YES” or other data value indicating that the button was activated by the user. In response to receiving the message 46, the message server may respond with a LCL CMD instruction 122c (FIG. 5c) to launch a “fat client” payment application resident on the client system 16.

In the event that the user selects the value in the quantity shipped field 230 of the first line, the message 46 will include (with the user ID and document ID) tagged data content comprises a data tag of <QTY1> and the data value of “3”. In response to receiving the message 46, the message server may retrieve a delivery confirmation document from the database 18 with a signature indicating receipt of the 3 units and provide such document to the plug-in module 24 as a new document 28.

In the event that the user selects the value in the product code field 232 of the first line, the message 46 will include (with the user ID and document ID) tagged data content comprises a data tag of <PROD> and the data value of “004”. In response to receiving the message 46, the message server may respond with an URL GET instruction 122a (FIG. 5a) to get a document (which includes information about the product with the code 004) from a specified web page.

Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the present invention. The present invention includes all such equivalents and modifications, and is limited only by the scope of the following claims.

1. A method of operating a message server:
a) sending a first portable document file to a client system, the first portable document file comprising data content selectable by the user;
b) receiving a message, the message comprising both:
identification of the first portable document file; and
identification of the displayed data content selected by the user;
c) using the identification of the first portable document file and the identification of the displayed data content selected by the user to build an instruction message instructing the client system to at least one of obtain a document at a specified network address and post data to a specified network address; and
d) providing the instruction message to the client system.

2. The method of operating a message server of claim 1, wherein the step of using the identification of the first portable document file and the identification of the displayed content selected by the user to build an instruction message comprises:
i) utilizing work flow tables to map the identification of the first portable document file and the identification of the displayed data content selected by the user to identification of one of a plurality of objects, each for building a different type of instruction message;
ii) retrieving variables needs for calling the one of the plurality of object for building the instruction message; and
iii) making a processing call to the object.

3. The method of operating a message server of claim 1:
wherein the message further comprises identification of the user of the client system;
the step of using the identification of the first portable document file and the identification of the displayed data content selected by the user to build an instruction message further comprises using the identification of the user of the client system to determine whether the user has permissions to data processing systems at the specified network address; and
the step of providing the instruction message to the client system comprises only providing the instruction message to the client system if the user of the client system has permissions to access the second portable document file.

4. The method of operating a message server of claim 3, wherein the step of using the identification of the first portable document file and the identification of the displayed content selected by the user to build an instruction message comprises:
i) utilizing work flow tables to map the identification of the first portable document file and the identification of the displayed data content selected by the user to identification of one of a plurality of objects, each for building a different type of instruction message;
ii) retrieving variables needs for calling the one of the plurality of object for building the instruction message; and
iii) making a processing call to the object.

5. The method of operating a message server of claim 4, wherein the step of providing instruction message to the client system only if the user of the client system has permissions to access the second portable document file comprises:
utilizing the work flow tables to map the identification of the user of the client system to an access level;
comparing the access level to a required access level; and
providing the instruction message to the client system only if the access level is greater than or equal to the required access level.

6. The method of operating a message server of claim 1, further comprising sending a message server address to the client system as a message server address update message that is a file distinct from the first portable document file, the message server address being an address at which the message is received.

7. The method of operating a message server of claim 6, wherein the step of using the identification of the first portable document file and the identification of the displayed content selected by the user to build an instruction message comprises:
i) utilizing work flow tables to map the identification of the first portable document file and the identification of the displayed data content selected by the user to identification of one of a plurality of objects, each for building a different type of instruction message;
ii) retrieving variables needs for calling the one of the plurality of object for building the instruction message; and
iii) making a processing call to the object.

8. The method of operating a message server of claim 6:
wherein the message further comprises identification of the user of the client system;
the step of using the identification of the first portable document file and the identification of the displayed data content selected by the user to build an instruction message further comprises using the identification of the user of the client system to determine whether the user has permissions to data processing systems at the specified network address; and
the step of providing the instruction message to the client system comprises only providing the instruction message to the client system if the user of the client system has permissions to access the second portable document file.

9. The method of operating a message server of claim 8, wherein the step of using the identification of the first portable document file and the identification of the displayed content selected by the user to build an instruction message comprises:
i) utilizing work flow tables to map the identification of the first portable document file and the identification of the displayed data content selected by the user to identification of one of a plurality of objects, each for building a different type of instruction message;
ii) retrieving variables needs for calling the one of the plurality of object for building the instruction message; and
iii) making a processing call to the object.

10. The method of operating a message server of claim 9, wherein the step of providing instruction message to the client system only if the user of the client system has permissions to access the second portable document file comprises:
utilizing the work flow tables to map the identification of the user of the client system to an access level;
comparing the access level to a required access level; and
providing the instruction message to the client system only if the access level is greater than or equal to the required access level.

11. A message server for dynamically managing the relationship between portable document file content and related data processing systems, the message system comprising:
a) a web server module:
i) providing a first portable document file to a client system, the first portable document file comprising data content selectable by the user;
ii) receiving a message from the client system, the message comprising both:
identification of the first portable document file; and
identification of the displayed data content selected by the user;
iii) providing an instruction message to the client system, the instruction message instructing the client system to at least one of obtain a document at a specified network address and post data to a specified network address; and
c) a work flow module using the identification of the first portable document file and the identification of the displayed data content selected by the user to select an instruction for inclusion in the instruction message and to select the specified network address.

12. The message server of claim 11, wherein the work flow module comprises work flow tables, the work flow module:
i) utilizing the work flow tables to map the identification of the first portable document file and the identification of the displayed data content selected by the user to identification of one of a plurality of objects, each object for building a different type of instruction message;
ii) retrieving variables needed for calling the one of the plurality of objects for building the instruction message; and
iii) making a processing call to the object.

13. The message server of claim 11 wherein:
the message further comprises identification of the user of the client system;
the work flow module further uses the identification of the user of the client system to determine whether the user has permissions to access the data processing services available at the specified network address; and
providing the instruction message to the client system occurs only if the user of the client system has permissions to access the data processing services available at the specified network address.

14. The message server of claim 13, wherein the work flow module comprises work flow tables, the work flow module:
i) utilizing the work flow tables to map the identification of the first portable document file and the identification of the displayed data content selected by the user to identification of one of a plurality of objects, each object for building a different type of instruction message;
ii) retrieving variables needed for calling the one of the plurality of objects for building the instruction message; and
iii) making a processing call to the object.

15. The message server of claim 14, wherein the work flow module further utilizes the work flow tables to:
map the identification of the user of the client system to an access level;
compare the access level to a required access level; and
provide the instruction message to the client system only if the access level is greater than or equal to the required access level.

16. The message server of claim 11, wherein the message server further sends a message server address to the client system as a message server address update message that is a file distinct from the first portable document file, the message server address being an address at which the message is received.

17. The message server of claim 16, wherein the work flow module comprises work flow tables, the work flow module:
i) utilizing the work flow tables to map the identification of the first portable document file and the identification of the displayed data content selected by the user to identification of one of a plurality of objects, each object for building a different type of instruction message;
ii) retrieving variables needed for calling the one of the plurality of objects for building the instruction message; and
iii) making a processing call to the object.

18. The message server of claim 16 wherein:
the message further comprises identification of the user of the client system;
the work flow module further uses the identification of the user of the client system to determine whether the user has permissions to access the data processing services available at the specified network address; and
providing the instruction message to the client system occurs only if the user of the client system has permissions to access the data processing services available at the specified network address.

19. The message server of claim 18, wherein the work flow module comprises work flow tables, the work flow module:
i) utilizing the work flow tables to map the identification of the first portable document file and the identification of the displayed data content selected by the user to identification of one of a plurality of objects, each object for building a different type of instruction message;
ii) retrieving variables needed for calling the one of the plurality of objects for building the instruction message; and
iii) making a processing call to the object.

20. The message server of claim 19, wherein the work flow module further utilizes the work flow tables to:
map the identification of the user of the client system to an access level;
compare the access level to a required access level; and
provide the instruction message to the client system only if the access level is greater than or equal to the required access level.
